(19) United States
(12) Patent Application Publication
(10) Pub. No.: US 2003/0220812 A1
(43) Pub. Date: Nov. 27, 2003

(54) Method of coordinating business transactions between repair service participants

(76) Inventors: Michael B. Jones, Mars, PA (US); Thomas S. Molenda, Gibsonia, PA (US); Julie A. Straub, Pittsburgh, PA (US); Stephen P. Jefferies, Mars, PA (US); William B. Viner, Cambridge, MA (US)

Correspondence Address: PPG INDUSTRIES INC, INTELLECTUAL PROPERTY DEPT, ONE PPG PLACE, PITTSBURGH, PA, 15272, US

(21) Appl. No.: 10/409,519

(22) Filed: Apr. 8, 2003

Related U.S. Application Data
(60) Provisional application No. 60/371,057, filed on Apr. 9, 2002.

(51) Int. Cl. G06F 17/60

(52) U.S. Cl. 705/1; 705/4

(57) ABSTRACT

The invention relates to a method for coordinating and/or arranging business transactions between the participants of a common economic marketplace by establishing and maintaining an electronic-based transaction community where participants conduct direct business-to-business communication, i.e., computer to computer communication, through an electronic hub where messages to and from the participants are received and routed.

### CROSS REFERENCE TO RELATED APPLICATION

This application claims priority to provisional application 60/371,057, filed on Apr. 9, 2002.

### BACKGROUND OF THE INVENTION

1. Field of the Invention

This invention relates generally to methods for coordinating or arranging business transactions and, in one particular embodiment, to a method for coordinating or arranging business transactions between the participants of a common economic marketplace.

2. Technical Considerations

In many commercial fields, the persons in need of goods and services, the providers of the goods and services, and third party payors (such as insurance companies) typically present a fragmented array of individual participants. The individual participants each have their own priorities and there is typically no organized approach for the participants to interact with each other to streamline individual transactions, reduce transaction time, reduce error generation, or improve the overall efficiency of a particular business transaction.

For example, in the field of automotive repair, individual repair shops typically receive work either directly from the policyholder of an insurance company or through the local insurance agent or regional claims adjuster for the insurance company. In most cases, this involves the policyholder telephoning the insurance company with information regarding repair or replacement needs and then the insurance company telephoning one or more service providers to arrange for the service to be provided to the policyholder. This can also require the sending of one or more mail correspondence or facsimiles between the insurance company and the selected service provider to formalize the work order and/or work assignments and/or to authorize particular work to be performed. After the work is completed, the repair shop sends an invoice to the insurance company or designated agent for payment. This invoice must then wind its way through the insurance company's financial department where it is checked for accuracy and then approved for payment. If errors are detected in the invoice, the insurance company must typically telephone or correspond with the service provider to correct the errors prior to payment being authorized. Moreover, during the course of the repair process, additional damage or service needs may be uncovered which were not originally authorized by the insurance company. In which case, the repair shop again has to either telephone or correspond with the insurance company to obtain authorization to conduct these additional repairs. Additionally, should the repair shop require a particular part not in inventory in order to perform the repair service, the repair shop must either telephone or correspond with a parts distributor or manufacturer to order the necessary part. In some cases, the insurance company may wish to be contacted for authorization before certain repair tasks are performed. This also requires either telephone or hard copy correspondence between the service provider and the insurance company.

This typical repair process depends heavily upon telephone calls, facsimile transmissions, and mail correspondence. This process tends to increase the time required to schedule and complete repairs, order parts, amend work orders or obtain additional work authorizations. Additionally, information sent between the insurance company and the service provider must typically be retyped and/or entered into the respective databases. This can facilitate data entry errors from hard copy and/or telephone messages being sent between the different participants. Additionally, the time required for submission of invoices and subsequent payment relies heavily upon how long it takes to send/receive the invoice, review the invoice, correct any errors, input the invoice information, authorize payment, and send/receive the payment.

As can be appreciated from the above, it would be advantageous to provide a method for coordinating business transactions between the participants in a particular economic marketplace which could reduce and/or eliminate at least some of the problems discussed above. Particularly, it would be advantageous to provide a method for coordinating business transactions between the participants of a common economic marketplace in which the need for some, if not all, of the telephone and hard copy communications between the participants could be reduced and/or eliminated. It would additionally be advantageous to provide a method for coordinating business transactions between the participants of a particular economic marketplace in which the participants could conduct direct business-to-business communication (e.g., computer to computer communication) to reduce error generation and/or the opportunity for error generation, to consolidate the overall business transaction, and/or to speed up and facilitate various aspects of the business transaction, such as work authorizations, work orders, parts ordering, invoicing, and payment procedures, just to name a few.

### SUMMARY OF THE INVENTION

The invention provides a method for coordinating business transactions between at least some of the participants of a common economic marketplace. In accordance with the invention, an electronic-based transaction community is established and maintained, e.g., by a hub coordinator, whereby authorized participants can conduct direct business-to-business communication (e.g., direct computer to computer communication) through an electronic hub where messages from the participants can be received and routed. In one embodiment, the invention provides a method of coordinating services, such as automotive glass repair services, between a plurality of service providers. The method includes coupling or linking the service providers to an electronic hub through an electronic network and enabling each service provider to contact at least one of the other service providers through the electronic hub. In one particular embodiment, a service coordinator can schedule and oversee the services. In another embodiment, the participants themselves can coordinate and oversee the services without a separate service coordinator.

In particular embodiments, the invention provides a method of coordinating repair services by means of an electronic hub, wherein an electronic service coordinator hub is provided having electronic communication links to each of a plurality of service providers and containing a plurality of processing rules corresponding to a plurality of approval entities; repair need information is obtained from a customer affiliated with a particular one of said approval entities; the repair need information is directed to the hub, and processing rules are assigned in accordance with the affiliated approval entity; an electronic work assignment is assembled, comprising the repair need information and the assigned processing rules; the electronic work assignment is directed to at least one of the service providers via the hub, said work assignment being adapted to be processed by shop management software provided at the service provider. Thus, the service provider's software receives guidelines for a pre-approved manner of performing the service along with the work assignment. If the service provider perceives a reason to deviate from the assigned processing rules (e.g., additional parts or parts of a different quality), the service responder may respond to the received work assignment with a modified electronic work proposal, which may be routed via the electronic hub to the approval entity. Subsequently, a communication may be directed to the service provider indicating whether authorization has been given to proceed with the service in accordance with the modified work proposal. In these embodiments, a wide variety of service providers may utilize the invention, but a particular market area in which the invention has found particular use is in the vehicle repair business, in which case the service providers may be collision repair shops, auto paint shops, auto glass replacement shops, etc. In those cases, the approval entity may be an insurance company, a service coordinator who is independent from the insurance company but acts on behalf of the insurance company to process claims, or the operator of a fleet of vehicles. An optional feature of the invention in the embodiments described above is the provision of means for the service providers, via the hub, to check their parts inventories and to communicate with suppliers regarding price and availability of needed materials to perform the work assignment.

Another particular example of one embodiment of the invention comprises coordinating automotive repair services between a customer of an insurance company and a plurality of service providers. The method includes coupling the insurance company and optionally a service coordinator to an electronic hub through a global communications network, coupling the service providers to the electronic hub through the global communications network, and enabling the insurance company or optional service coordinator to contact one or more of the service providers through the hub.

A further method of coordinating automotive repair services in accordance with the insurance company comprises providing an electronic hub and coupling one or more service providers selected from at least one insurance company, at least one automotive glass repair shop, at least one glass product distributor, and optionally at least one service coordinator to the electronic hub through a global communications network. The service providers can contact at least one of the other service providers and the optional service coordinator through the hub.

An additional method of coordinating automotive repair services for the customer of an insurance company comprises the steps of providing an electronic hub, coupling at least one insurance company, at least one automotive repair shop, at least one automotive parts distributor, and optionally at least one service coordinator to the electronic hub through a global communications network, obtaining service need information from the customer, directing a work assignment from the insurance company or the service coordinator to the repair shop via the electronic hub, directing a parts order from the repair shop to the distributor via the electronic hub, and directing an invoice from the repair shop to the insurance company or the service coordinator via the electronic hub.

### DESCRIPTION OF THE INVENTION

As used herein, the term “services” is not limited to labor only but can include parts alone, labor alone, or both parts and labor. Likewise, the term “service provider” can include a provider who supplies parts alone, labor alone, or a combination of parts and labor. The term “business transaction” means an act or process in furtherance of a business deal or commercial transaction and typically involves an exchange of money (whether actual cash or electronic credits/debits) for parts and/or services. The term “common economic marketplace” refers to a group or association of participants engaged in related business activity, e.g., providing parts and/or services in a particular commercial field or area of business. The term “transaction community” refers to selected members of the common economic marketplace participating in the method of the invention. The term “motor vehicle” means any type of conventional motorized transportation device, such as but not limited to automobiles, trucks, motorcycles, snowmobiles, tractors, and the like.

The invention relates generally to a method for coordinating business transactions between the participants of a common economic marketplace. An electronic-based transaction community is established and maintained in which the participants can conduct direct business-to-business communication through an electronic “hub” or routing network where messages to and from the participants are received and routed. By “direct business-to-business communication” is meant computer to computer communication. The communication can be conducted by any conventional method, such as via the Internet, telephone lines, T-1 lines, cables, or in any other desired manner. An exemplary practice of the invention will be described hereinafter with particular reference to coordinating repair services for a policyholder of an insurance company in an automotive repair/replacement economic marketplace, such as but not limited to an automotive glass repair/replacement economic marketplace. However, it is to be understood that the invention is not limited to use with insurance company policyholders but could be used for a variety of customers, such as but not limited to employees of a particular company, members of a particular organization or association, third party payors, and individual cash payors, just to name a few. Additionally, the invention is not limited to the field of automotive glass repair/replacement but could be practiced in many different fields, such as but not limited to motor vehicle (e.g., automotive) collision repair, motor vehicle (e.g., automotive) paint refinishing, clothing repair, plumbing services, medical services, parts supply services, retail and/or wholesale merchandise services, motor vehicle parts services, motor vehicle rental services, fire repair services, purchasing services, and home repair services, and others.

An exemplary automotive repair/replacement transaction community illustrating the practice of the invention includes a plurality of participants. In this non-limiting exemplary embodiment, the transaction community will be discussed in terms of a glass repair/replacement transaction community in which the participants can include one or more insurance companies (or claims administrators) with an in-house computer system, one or more service providers (e.g., automotive glass repair shops, refinish shops, collision repair shops, and the like), one or more distributors (e.g., automotive parts distributors, glass distributors, paint distributors, and the like), one or more manufacturers (e.g., glass manufacturers, automotive parts manufacturers, and the like), a hub coordinator, and an optional service coordinator. In one embodiment, the hub coordinator forms and maintains the transaction community of participants as described below. In another embodiment, the service coordinator can coordinate the particular services required by a customer from the service providers. As will be appreciated by one skilled in the art, the particular participants of the transaction community will depend upon the specific economic marketplace involved and the particular type of goods and services needed.

In the practice of the invention, the participants can be coupled by electronically linking one or more of the participants with one or more of the other participants through a communications network via an electronic “hub” where messages from the participants can be received and routed as described below. The term “electronically linked” refers to any conventional method of exchanging, sending, and/or receiving information via an electronic network (such as but not limited to connections utilizing modems and personal computers, over the Internet via the, world-wide-web, or any precursor or successor, or the like). The electronic link can include electronic mail (e-mail) correspondence, accessing a web page or website, or by sending and/or receiving messages via an electronic network having interactive protocol (e.g., FTP, etc.), and can be performed via any type of connection, such as but not limited to telephone lines, an electronic network (such as a conventional computer network or via the world-wide-web), or via one or more direct access lines (such as one or more T1 lines, without going over the world-wide-web). In one particular embodiment, the participants can be electronically linked with one or more of the other participants via the Internet to the hub. Each of the participants has a computer or computer system with software capable of authenticating and/or formatting a message in a particular format as described below and sending and/or receiving such formatted messages. The computers and/or software of each participant need not be exactly the same as long as the particular hardware and/or software of each participant are capable of sending and/or receiving formatted messages through the hub to and from the other participants.

The hub can be located with the hub coordinator and include one or more electronic routing devices, such as one or more conventional “servers” to receive and route formatted and/or encrypted messages to and from the participants. One example of a suitable server to connect the participants is the BizTalk® server commercially available from Microsoft. Alternatively, the server can be located at or based with the service coordinator.

An exemplary practice of the invention in the field of automotive glass repair/replacement will now be described. However, it is to be understood that the following discussion is simply to explain the general concepts of the invention and that the invention is not limited to the field of automotive glass repair/replacement or to the specifically described exemplary practice.

In one practice of the invention, the hub coordinator establishes and maintains an electronic based transaction community where the participants can conduct direct business-to-business, i.e., direct computer to computer, communication. The transaction community can be established by the hub coordinator by contacting members of the common economic marketplace to ascertain which members of the economic marketplace would be interested in joining the transaction community, i.e., become participants in the transaction community. The hub coordinator could then provide those parties interested in joining the transaction community with appropriate software (or business logic) and/or hardware to enable the participants to format messages in a particular manner to be received and understood by other participants and/or software to enable the participants to access and send/receive messages through the electronic hub. The particular software or operating systems utilized by the participants is not critical so long as whatever software is utilized is capable of formatting messages in a desired manner to be received and understood by the other participants and/or to be routed through the hub. Examples of suitable software include BreakAway™ software and GlasPac® LX software, both commercially available from GTS Services, LLC of Portland, Oreg. In another embodiment, the service coordinator can establish and maintain the transaction community, e.g., on an electronic database.

In one embodiment, the participants interested in joining the transaction community can pay the hub coordinator a fee for joining the transaction community. Alternatively, the hub coordinator can charge a fee to the various participants for each business transaction they are involved with, e.g., a flat fee for each message sent and/or received by a particular participant. Should a participant in the transaction community no longer wish to participate, the hub coordinator could request return of the previously supplied software. Alternatively, the hub coordinator could configure or program the hub to no longer send and/or receive messages to or from the withdrawn participant.

For example, the hub coordinator can provide the participants with a particular set of business logic with which to conduct specific tasks in the transaction community, such as send work orders, authorize certain work to be conducted, order parts, ship parts, etc. By “business logic” is meant a specific set of steps and a specific message format by which a certain task (e.g., message) is to be constructed, sent, routed, and/or authenticated via the hub. The business logic allows proper interpretation of received messages by the recipient's computer system and proper format of a response. The business logic also includes rules established by the approval entity for performance of the service. In particular, in those embodiments involving insurance claims for repair services, the business logic includes rules for carrying out the repair, which if adhered to, will result in payment of the insurance claim.

In the practice of the invention, the hub coordinator establishes a message format (business logic) to be used by each participant to send/receive messages via the hub. For example, the message can be an “XML” standard message and can be in “Electronic Data Interchange” (EDI) format. The particular format utilized is not critical so long as each participant adheres to the selected format. The content of each message is determined by the selected business logic.

The invention can be practiced by a wide variety of customers, such as but not limited to insurance company policyholders, employees of a particular company, members of a particular organization or association, third party payors, or individual cash payors, just to name a few. For example, the customer can be a member of a particular company or organization having a working relationship with the service coordinator. Alternatively, the customer may be an individual consumer.

In one practice of the invention, when a customer desires a particular service, the customer can contact the service coordinator to arrange for the services to be provided. The customer may contact the service coordinator directly. Alternatively, if the customer is a member of a qualified organization (such as one of the insurance companies) doing business with the service coordinator, the customer can first contact the insurance company which then contacts the service coordinator, with or without the customer. The service coordinator can obtain particular service need information and, optionally, can verify the customer's authorization to request the services and/or confirm the customer's payment information, e.g., credit card number. As will be appreciated, the particular service need information depends upon the particular field of services desired by the customer.

In the exemplary automotive glass repair/replacement process under discussion, when the customer (e.g., a policyholder of the insurance company) suffers an automotive glass loss or damage, such as damage to a windshield, sidelight, back light, etc., the customer can contact his insurance company either directly or through a designated agent, such as the policyholder's local agent or claims adjuster. This contact can be conducted in any conventional manner, such as by telephone, via e-mail, in person, or in any other conventional manner. The insurance company and the customer can together contact the service coordinator. Alternatively, as discussed above, the customer can contact the service coordinator directly, e.g., telephonically.

In either case, upon initial contact the service coordinator can verify the customer's authority to request the services, e.g., that the customer has an up-to-date insurance policy with the insurance company. For example, the service coordinator can access the computer system of the insurance company to obtain this information. This access can be through the hub or via any other conventional electronic data link, e.g., such as a direct line or through a modem. Alternatively, the service coordinator can have and maintain a database of the relevant information of one or more of the insurance companies in the transaction community such that the service coordinator would not have to contact the insurance company. Assuming the customer has a valid insurance policy with the insurance company, the service coordinator obtains service need information, such as the make and model of the vehicle, the policyholder's location, the extent of the damage, type of damage, date of damage, cause of damage, whether the vehicle is mobile, etc.

The service coordinator can check the availability of the repair shops to conduct the needed repair by formatting a message to all or a selected portion of the repair shops. The message can be sent from the service coordinator to the repair shops (e.g., the repair shops' computers) via the hub. In the broad practice of the invention, a message in the appropriate business logic can be sent directly (via coupling) from the computer of the service coordinator, through the hub, and directly to the computers of the repair shops. As part of the invention, the repair shops can have in their computer system indicia (such as a number or letter designation indicating the availability of that particular repair shop to conduct any additional repairs. Upon receipt of the message from the service coordinator, the software on the various repair shop computers can access the availability indicia of the particular repair shop and automatically send a response in the selected business logic format to the service coordinator indicating the availability of that particular repair shop to conduct any further repairs. Thus, no actual input from an employee at the repair shop(s) is needed to respond to the formatted message from the service coordinator.

Upon receipt of the responses from the contacted repair shops, the service coordinator can select a particular repair shop to conduct the repair (with or without input from the policyholder). The selection of the repair shop to conduct the repair can be in any manner desired by the service coordinator, the insurance company, or the insured. For example, the repair shop selected can be the closest repair shop to the customer's location or home address, the repair shop having the highest current availability, the repair shop to which work has not been recently sent, or in any desired manner. For example, the selection of the particular repair shop to conduct the repair can be made in accordance with the ranking and/or selection methods described in U.S. patent application Ser. No. 09/618,809 or U.S. Provisional Application No. 60/333,628, both of which applications are herein incorporated by reference in their entirety.

Upon selection of the repair shop, the service coordinator formats and sends an electronic work order to the selected repair shop via the hub. In the practice of the invention, the messages transmitted by the participants via the hub include a destination code or address such that when a message is received by the hub (e.g., a server), the message can be routed automatically to the correct recipient. The hub routes the messages but does not actually respond to the messages. The participants can utilize any conventional software/hardware capable of accessing the hub provided the participant can correctly format the message according to the business rules to be recognized and routed by the hub.

In one aspect of the invention, if the message sender is using one computer system and/or software and the intended message recipient is using another computer system and/or software, the hub coordinator can “translate” or convert the sender's format into a format readable by the recipient's computer system in conformance with the business rules. For example, if the sender is using Microsoft Word software and the recipient is using WordPerfect software, the hub can convert the Word message into a WordPerfect message readable by the recipient. This conversion can be done using any conventional methods, such as by using Microsoft BizTalk software to automatically convert the sender's message into a form that is readable by the intended recipient. Thus, an advantage of the invention is that two participants with different software systems can communicate without having to change their existing systems. The business transactions in accordance with the invention can be integrated into their existing systems.

Upon receipt of the work order, the selected repair shop can electronically direct an estimated repair cost to the service coordinator via the hub before conducting the work. Additionally, the repair shop can request coverage verification and/or work authorization from the service coordinator via the hub. Based upon the information in the work order, the repair shop (e.g., the repair shop's computer system) can identify the parts required to complete the repair and can check its inventory to see if the parts are on hand.

If one or more of the required parts are not in inventory, the repair shop can contact one or more of the distributors via the hub to request quotes, parts availability, shipping dates, etc. This contact can be initiated automatically by the repair shop's computer system upon searching the repair shop's database and discovering that the required part is not listed in inventory. The distributors (e.g., the distributors' computer systems) can automatically check the distributors' inventory for the required part and automatically format and send a response to the repair shop via the hub. For example, the computer system of the repair shop can send a formatted message directly to the computer systems of the distributors requesting parts availability. The distributors' computer systems can access their inventory records and automatically send a response to the repair shop without the need for human intervention.

The repair shop can then select a particular distributor to supply the needed part(s) and can send a formatted order to the selected distributor via the hub. The order can include shipping and handling instructions and, upon receipt of the order, the computer system at the distributor can automatically schedule the required part for shipment to the repair shop. When the part is received by the repair shop, the repair shop can pay the distributor, e.g., by an electronic funds transfer and can notify the distributor of payment via the hub.

The repair shop can then conduct the repair. Upon completion of the repair, the repair shop can send an invoice to the service coordinator via the hub and the service coordinator can arrange payment to the repair shop or can arrange for the insurance company to pay the repair shop. Prior to payment of the invoice, the service coordinator (e.g., the service coordinator's computer system) can compare the repair shop bill against the work order to make sure that there are no errors in the bill. If there are errors, the service coordinator can contact the repair shop via the hub to correct the errors and the repair shop can then submit a corrected bill to the service coordinator via the hub. Alternatively, the service coordinator can simply correct the bill and notify the repair shop of the correction. If there are no errors or if the errors have been corrected in the bill, the service coordinator can forward the repair shop bill to the insurance company and the insurance company can remit payment to the service coordinator. The service coordinator can then remit payment to the repair shop. Alternatively, the insurance company can remit payment directly to the repair shop.

In one aspect of the invention, the business logic utilized to format messages can include logic to notify the insurance company and/or service coordinator if certain parts are required during the course of the repair to receive specific authorization for those parts and/or services. For example, an insurance company may wish to be informed if new molding is required for a particular repair. This information can be included in the business logic. A repair shop database can track the list of parts used on a particular repair job. If new molding is added to the list of parts, the computer system at the repair shop can automatically format and send a message to the insurance company to request authorization for molding replacement. When the message is received by the insurance company, the insurance company computer can check to see if such an authorization is permissible within the confines of the repair job and can then format and send an appropriate response, such as an authorization, to the repair shop. For example, a message in one suitable XML business logic format in which an insurance company for a particular job requires subsequent approval of the replacement of a license sticker. When “license sticker” is identified by the repair shop as one of the parts required to complete the job, the repair shop's computer system can automatically format and send an authorization request to the insurance company.

It should be appreciated that the hub coordinator (or business logic) can limit access between participants if one or more of the participants so desire to limit or prevent access by one participant to confidential and/or trade secret information of another participant. For example, it is understandable that one insurance company may not wish another insurance company to be able to access information from the insurance company's database, such as customer names, cost and price information, etc. This could be accomplished by incorporating steps in the business logic to block receipt or response to messages from selected participants if a participant so desires. Further, not every participant may wish to do business with every other participant for various reasons, such as previous billing problems, poor performance, failure to meet promised deadlines, etc. For example, one glass distributor may not wish to do business with a particular repair shop because the repair shop has done a poor job in the past. In this case, the distributor can request that the hub coordinator change the business logic such that the distributor does not receive messages from that repair shop. Alternatively, the distributor's computer system can automatically send a response indicating that the repair shop's request or order is not authorized until the previous problem(s) are resolved.

Moreover, the business logic can include an authentication code to identify authorized participants, e.g., those participants authorized to do business with selected other participants through the hub. The authentication code can eliminate unauthorized attempts to access or utilize the transaction community by persons not in the transaction community. For example, if a glass distributor receives a request (message) for glass but the message does not have the proper authentication code for a repair shop authorized or approved to do business through the hub with that distributor, the request is not honored. This authorization to send/receive messages can be determined by the service coordinator (e.g., authorization only for participants in the transaction community) or can be requested by one or more of the individual participants.

While in the above example the service coordinator arranged the repair process for the customer, in another embodiment of the invention the insurance company itself could coordinate and arrange the repair process for the customer, such as by scheduling the repair, selecting the repair shop, sending the work authorization, and/or making electronic funds transfers.

The invention enables the participants in the transaction community to manage their respective business transactions with consistent and accurate information, provides immediate feedback, reduces overhead and back-office costs, provides new partnering opportunities, helps the participants move from a labor-based ordering process to an automated ordering process, and increases overall transaction efficiency. For example, since the majority of the messages sent and/or received by the transaction community participants are automatically formatted by their respective computer systems in accordance with the selected business logic, there is no need for intermediate data entry that could introduce transcription or input errors. Moreover, the time required to conduct a business transaction can be reduced since formatted messages can be sent and/or received well outside the normal working hours for a particular participant. For example, a repair shop can identify a required part needed for a repair. The repair shop computer system can send a request for the part to a selected distributor well after the distributor has technically closed for the day to receive customers in person. However, the message can be received and interpreted by the distributor's computer system, the inventory checked for the part, and a shipping order automatically generated for the part without the need for human intervention.

It will be readily appreciated by those skilled in the art that modifications can be made to the invention without departing from the concepts disclosed in the foregoing description. For example, the present method and apparatus are not limited to the exemplary automotive glass repair/replacement field discussed above but could be easily adapted for other fields or other types of customers. Accordingly, the particular exemplary embodiments described in detail herein are illustrative only and are not limiting to the scope of the invention, which is to be given the full breadth of the appended claims and any and all equivalents thereof.

What is claimed is:

1. A method of coordinating repair services by means of an electronic hub, wherein:
an electronic service coordinator hub is provided having electronic communication links to each of a plurality of service providers and containing a plurality of processing rules corresponding to a plurality of approval entities;
repair need information is obtained from a customer affiliated with a particular one of said approval entities;
the repair need information is directed to the hub, and processing rules are assigned in accordance with the affiliated approval entity;
an electronic work assignment is assembled, comprising the repair need information and the assigned processing rules; and
the electronic work assignment is directed to at least one of the service providers via the hub, said work assignment being adapted to be processed by shop management software provided at the service provider utilizing the assigned processing rules for the particular work assignment.

2. The method of claim 1 wherein the hub additionally provides communication with at least one supplier to the service provider, and the service provider obtains information via the hub from one or more of said suppliers in preparing the electronic work proposal.

3. The method of claim 1 wherein at least one of the approval entities is an insurance provider.

4. The method of claim 1 wherein at least one of the approval entities is a vehicle fleet operator.

5. The method of claim 1, including coupling a service coordinator to the electronic hub.

6. The method of claim 1, wherein the repair service comprises automobile repair.

7. The method of claim 6, wherein at least one of the suppliers includes an automobile parts supplier.

8. The method of claim 1, wherein the service provider, upon receipt of an electronic work assignment, electronically accesses parts inventory to establish parts-on-hand for completing the work assignment.

9. The method of claim 8, wherein the service provider, upon determining insufficient inventory, sends a parts order to the supplier via the electronic hub.

10. The method of claim 5, wherein the service providers include at least one motor vehicle glass repair provider.

11. The method of claim 1, including directing an estimate of the cost of the repair from the service provider to one of said approval entities.

12. The method of claim 11, including directing a work authorization from the approval entity to the repair shop via the electronic hub.

13. The method of claim 1 wherein the approval entity is a service coordinator independent from but managing processing rules from a plurality of insurance companies.

14. The method of claim 1, including directing an invoice from the service provider to the approval entity via the electronic hub.

15. The method of claim 14, including directing a notification of payment from the approval entity to the service provider via the electronic hub.

16. The method of claim 1, including checking the availability of the service provider to conduct the service via the hub prior to directing the work assignment.

17. The method of claim 1 further including the service provider responding to a received work assignment by submitting via the hub an electronic work proposal that deviates from the assigned processing rules associated with the received work assignment; and the electronic work proposal is routed to at least one of the approval entities for approval to proceed with the service in accordance with the work proposal.

18. A method of coordinating repair services by means of an electronic hub, wherein:
an electronic service coordinator hub is provided having electronic communication links to each of a plurality of service providers and containing a plurality of processing rules corresponding to a plurality of approval entities;
notice of loss information is obtained by a service provider from a customer affiliated with a particular one of said approval entities;
notice of loss information is communicated by the service provider via the hub to at least one of the approval entities;
the approval entity responds to the service provider via the hub with assignment of processing rules for carrying out service for the particular loss reported;
the service provider accepts the assigned rules via the hub; and
an electronic work assignment is directed via the hub to the service provider, comprising the repair need information and the assigned processing rules.
